(19) United States
(12) Patent Application Publication
(10) Pub. No.: US 2007/0084541 A1
(43) Pub. Date: Apr. 19, 2007

(54) Method and apparatus for inspecting pneumatic tire during production

(75) Inventors: Kinya Moriguchi, Osaka-shi (JP); Hajime Watanabe, Osaka-shi (JP); Osamu Yamashita, Osaka-shi (JP)

Correspondence Address: JORDAN AND HAMBURG LLP, 122 EAST 42ND STREET, SUITE 4000, NEW YORK, NY, 10168, US

(73) Assignee: Toyo Tire & Rubber Co., Ltd., Osaka-shi (JP)

(21) Appl. No.: 11/526,439

(22) Filed: Sep. 25, 2006

(30) Foreign Application Priority Data
Oct. 17, 2005 (JP) 2005-302234

(51) Int. Cl. B29D 30/08

(52) U.S. Cl. 156/117; 156/397; 156/64; 73/146

(57) ABSTRACT

There is provided an inspection method for inspecting an object built on a tire building drum to make up a pneumatic tire with respect to profile thereof in process of production of the tire includes, in which data with respect to a profile of the object for a single rotation of the tire building drum is acquired by a two-dimension laser sensor having a detection range along a lateral direction of the object while rotating the drum. Then, using the data so acquired, a radial run-out (RRO) in a circumferential direction of the tire is averaged out in a lateral direction of the object for harmonic analysis, and whether or not the magnitude of the harmonic obtained as a result of the analysis falls within a predetermined range is determined.

### CROSS-REFERENCE TO RELATED APPLICATION

This application is based upon and claims the benefit of priority from the prior Japanese Patent Application No. 2005-302234, filed on Oct. 17, 2005; the entire contents of which are incorporated herein by reference.

### BACKGROUND OF THE INVENTION

1. Field of the Invention

The present invention relates to a method and apparatus for inspecting a pneumatic tire with respect to at least part of a profile thereof during production. The invention also relates to a method for producing a pneumatic tire by making use of the inspection method.

2. Description of the Related Art

Low uniformity of pneumatic tires causes vibrations in a vehicle. Due to this, force variations occurring when they rotate are measured on pneumatic tires after production, and tires showing large force variations are disposed as defectives.

The variability of constituent members of tires being produced that occurs in steps of the tire production process is considered to constitute one of the causes which deteriorate the uniformity of completed tires. Conventionally, however, there has existed no process control system which controls the production process from the viewpoint of the uniformity, and hence, it is not until the uniformity of a completed tire is measured that a defect associated with low uniformity is found. Investigations for suspected causes of the defect are then carried out in the individual production steps to find eventually that the mechanical accuracy associated with one step caused the defect. This cause locating process is the case that often happens with the deteriorated uniformity-related defect.

Due to this way of dealing with the defect, there have been caused problems that all tires that had passed through the relevant step until the defect was found are now defective, making lots of defectives to be discarded and that the production, which had been stopped when the defect was found, cannot not be resumed until the cause is verified.

The Japanese Unexamined Patent Publication (Kokai) No. 2004-354258 describes a method for inspecting joint portions on a belt ply made by joining circumferentially short strip-like sheet members together where end portions thereof are joined to each other by wrapping the belt ply around a tire building drum and measuring a radial run-out of the belt ply in the circumferential direction with a one-dimension laser sensor while rotating the tire building drum in that state.

While it is considered to measure a fluctuation on the circumference of a tire using the laser sensor in the way described above, in a tire fabrication technique of affixing a ribbon-shaped material, since there are caused irregularities in a lateral direction, the evaluation of only a single point in the lateral direction by the one-dimension laser sensor is insufficient, and it is hard to detect a defect such as a tear of the ribbon-shaped material. Namely, in pneumatic tire production methods, there occurs a case where a process is adopted in which a ribbon-shaped rubber is wound spirally around a tire building drum along a circumferential direction of a tire in order to form a tread portion or the like (for example, the Japanese Unexamined Patent Publication (Kokai) Nos. 2002-178415, 2002-205512 and the like). When this fabrication technique is adopted, irregularities matching a lateral shift amount of the ribbon-shaped rubber resulting every time the rubber completes a single circulation around the full circumference of an object built on the tire building drum are formed on the surface of the object in the lateral direction. In addition, since the irregularities are provided in such a state that they are inclined relative to the circumferential direction of the tire due to the ribbon-shaped rubber being spirally wound around the tire building drum, circumferential fluctuations which would affect the uniformity of the tire when completed as a final product cannot be measured accurately when the fluctuations are attempted to be measured circumferentially at a single point in the circumferential direction.

In addition, the Japanese Unexamined Patent Publication (Kokai) No. 2004-354259 discloses a method for inspecting a tread rubber built on a tire building drum with respect to a contour configuration using a laser sensor. However, this document relates to the inspection of the contour configuration in the lateral direction of the tread rubber while moving the one-dimension laser sensor in the lateral direction of the tread rubber and does not disclose an inspection a radial run-out in the circumferential direction which constitutes a cause for deterioration of the uniformity of a tire.

Additionally, the Japanese Unexamined Patent Publication (Kokai) No. 2004-299184 discloses, in relation to a tire fabricating technique of spirally winding a ribbon-shaped material, a method for measuring a profile of the ribbon-shaped material so wound. The method disclosed in the relevant document, however, is such as to measure a displacement amount of the ribbon-shaped rubber immediately after it has been wound by moving a one-dimension laser sensor in such a manner as to follow the ribbon-shaped rubber while winding the ribbon-shaped rubber, and due to this, the configuration of a measuring apparatus used is complicated, and a problem with measuring accuracy is easy to be caused.

### SUMMARY OF THE INVENTION

The invention was made in the light of the views pointed out above and an object thereof is to provide an inspection method and inspection apparatus which can accurately measure a profile, which largely affects the uniformity of a completed tire, of an object built on a tire building drum by shifting laterally a ribbon-shaped material every time the material completes a single circumferential circulation around the tire building drum or winding spirally the ribbon-shaped material around the tire building drum in the midst of production of a tire to thereby reduce largely the amount of defects that are generated in association with the profile, as well as time until the once-stopped production is resumed.

According to the invention, there is provided an inspection method for inspecting an object built on a tire building drum to make up a pneumatic tire with respect to a profile thereof in process of production of the tire, including acquiring data with respect to a profile of the object for a single rotation of the tire building drum by a two-dimension laser sensor provided in close proximity to the object on the tire building drum and having a detection range following along a lateral direction of the object while rotating the tire building drum, calculating a harmonic of a radial run-out in a circumferential direction of the tire which is averaged out in the lateral direction of the object by performing harmonic analysis on the data so acquired, and determining whether or not the magnitude of the harmonic so calculated falls within a predetermined range.

In addition, according to the invention, there is provided an inspection apparatus for inspecting an object built on a tire building drum to make up a pneumatic tire with respect to a profile thereof in process of production of the tire, including a two-dimension laser sensor provided in close proximity to the object on the tire building drum and having a detection range following along a lateral direction of the object, a data acquisition unit for acquiring data with respect to a profile of the object for a single rotation of the tire building drum by the two-dimension laser sensor, a data processing unit for calculating a harmonic of a radial run-out in a circumferential direction of the tire which is averaged out in the lateral direction of the object by performing harmonic analysis on the data so acquired, and a determination unit for determining whether or not the magnitude of the harmonic so calculated falls within a predetermined range.

In the above configuration, when calculating a harmonic of the radial run-out in the circumferential direction of the tire which is averaged out in the lateral direction of the object, the radial run-out in the circumferential direction of the tire may be averaged out with respect to the lateral direction of the object, so that the radial run-out so averaged out is harmonic-analyzed to thereby calculate the intended harmonic. Alternatively, the data may be divided into sections of a predetermined width over the object, so as to perform harmonic analysis on a radial run-out in the circumferential direction of the tire in each section, so that harmonics in the circumferential direction of the tire so obtained for the individual sections are averaged out in the lateral direction of the object to thereby calculate the harmonic in the circumferential direction of the tire which is averaged out in the lateral direction of the object.

In an embodiment of the invention, the data may be divided into sections of a predetermined width over the object, so as to perform harmonic analysis on a radial run-out in the circumferential direction of the tire in each section so divided, and whether or not the magnitude of the harmonic in the circumferential direction of the tire obtained for each section falls within a predetermined range may then be determined.

In addition, whether or not the amount of irregularities existing locally on the profile of the object falls within a predetermined range may be determined from the data.

While there is imposed no limitation on the invention in any way, the invention will be effective when applied to a case where the object is formed by winding a ribbon-shaped material around the tire building drum by shifting the ribbon-shaped material in the lateral direction every time the material completes a circumferential circulation of the drum or winding spirally the ribbon-shaped material around the tire building drum. In addition, in this event, the predetermined width by which the data is divided into the sections may be set larger than a lateral shift amount of the ribbon-shaped material in which the ribbon-shaped material is caused to shift laterally every time it completes a single circumferential circulation around the tire building drum.

In addition, according to the invention, there is provided a pneumatic tire production method including building on a tire building drum an object which makes up a pneumatic tire by shifting a ribbon-shaped material laterally every time the ribbon-shaped material completes a single circumferential circulation around the tire building drum or winding spirally the ribbon-shaped material around the drum, acquiring data with respect to a profile of the object for a single rotation of the drum by a two-dimension laser sensor provided in close proximity to the object on the tire building drum and having a detection range following along the lateral direction of the object while rotating the tire building drum, calculating a harmonic of a radial run-out in a circumferential direction of the tire which is averaged out in the lateral direction of the object by performing harmonic analysis on the data so acquired, determining whether or not the magnitude of the harmonic so calculated falls within a predetermined range, and vulcanizing to mold a pneumatic tire using the object for which the magnitude of the harmonic is determined to fall within the predetermined range.

According to the invention, by measuring the profile of the tire in a planar fashion using the two-dimension laser sensor in the midst of production, the radial run-out in the circumferential direction, which affects largely the uniformity of the tire when completed as a final product, can be accurately measured in the midst of production even on the tire produced through the process of shifting the ribbon-shaped material in the lateral direction every time the material completes its circumferential circulation around the tire building drum or winding spirally the ribbon-shaped material around the tire building drum.

In addition, when determining whether or not the amount of irregularities existing locally on the profile of the object falls within a predetermined range from the data measured by the two-dimension laser sensor, an abnormality such as a tear of the ribbon-shaped material can be detected.

Additionally, since defects can be detected in the midst of production in such a way, the defects so detected can be dealt within the early step, thereby making it possible to reduce the generation of the defects substantially, thus reducing costs for materials. In addition, a failed location in the mechanical facility can be identified early, so as to enable the failure to be dealt with in a smooth fashion, thereby making it possible to reduce time during which the relevant mechanical part of the facility is out of operation.

### BRIEF DESCRIPTION OF THE DRAWINGS

FIG. 1 is an exemplary diagram which shows the configuration of an inspection apparatus according to an embodiment of the invention.

FIG. 2 is a flowchart which shows the flow of a process according to the embodiment.

FIG. 3 is a sectional view of a pneumatic tire in a lateral direction of a tread thereof.

FIG. 4 is a plan view which shows an object on a tire building drum which constitutes a target for inspection.

FIG. 5A is a graph of RRO in some section before a harmonic analysis is performed, and FIG. 5B is a graph of a first harmonic of RRO.

FIG. 6 is a graph which shows all waveforms of first harmonics of RRO in individual sections on the object and a waveform of a first harmonic of RRO which is averaged out over an overall width of the object.

FIG. 7A is a graph of RRO of the overall width before a harmonic analysis is performed, and FIG. 7B is a graph of a first harmonic of RRO of the overall width.

FIG. 8 is a graph which shows a relationship between the magnitude of a first harmonic of RRO of a green tire and the magnitude of a first harmonic of RFV of a completed tire as a final product.

### DETAILED DESCRIPTION OF THE INVENTION

Hereinafter, an embodiment of the invention will be described by reference to the accompanying drawings.

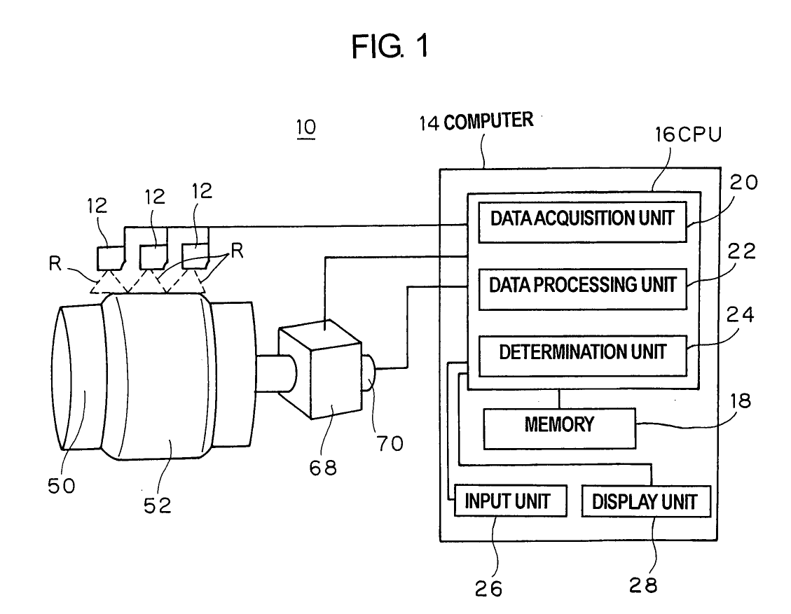

FIG. 1 is an exemplary diagram which shows the configuration of an inspection apparatus 10 according to an embodiment of the invention. This inspection apparatus 10 includes a two-dimension laser sensor 12 which are provided in close proximity to an object 52 built on a tire building drum 50 and a computer 14.

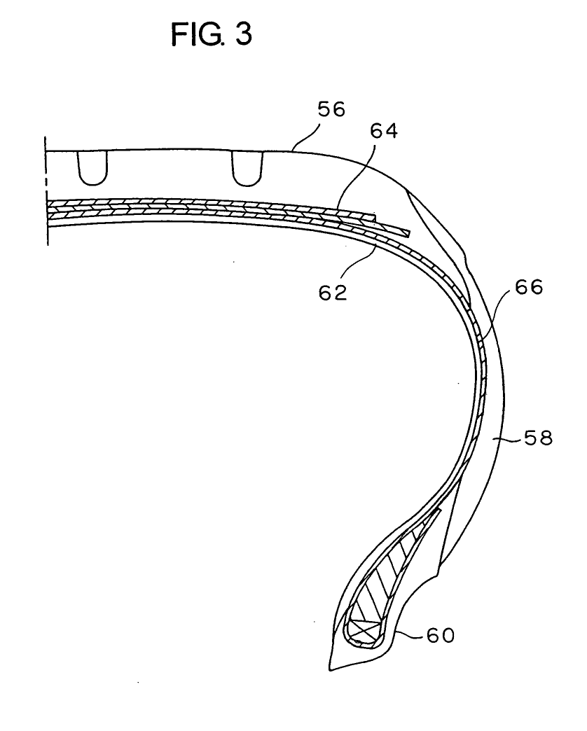

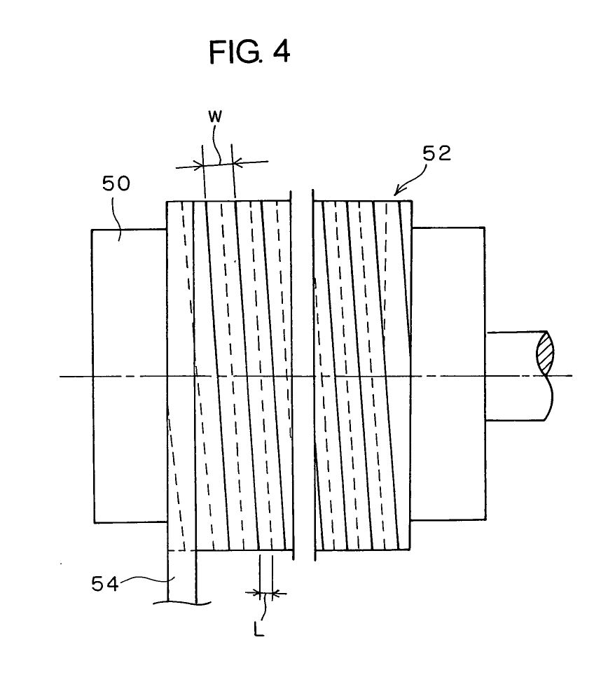

The annular object 52 which makes up part of a tire is built on the tire building drum 50. In an example shown in FIG. 4, this object 52 is built by winding spirally a ribbon-shaped rubber 54 on the tire building drum 50 along a circumferential direction of the tire in such a manner as to overlap, so as to make up a tread portion 56 of the tire (refer to FIG. 3). To be more specific, a green tire is formed on the tire building drum 50 which is a tire which has not yet been vulcanized but has been built, and a tread portion thereof is formed by winding the ribbon-shaped rubber 54 on a belt ply, and the tread portion so formed is made to constitute the object 52 which is a target for inspection. In addition, while there is no specific limitation on the width w of the ribbon-shaped rubber 54, normally, the width w is 15 to 90 mm. Additionally, although not shown, instead of the spiral winding of the ribbon-shaped rubber 54, the object 52 may be built by a technique of winding the ribbon-shaped rubber 54 on the tire building drum 50 in the circumferential direction of the tire at an angle of 0° until the rubber completes its full circumferential circulation around the drum, and then shifting the ribbon-shaped rubber 54 (or causing the ribbon-shaped rubber 54 to deviate) slightly in a transverse direction of the tire every time the rubber completes the full circumferential circulation around the drum for continuation of the winding. In this technique, although there occurs no case where edges of the ribbon-shaped rubber 54 so wound are aligned to run diagonally across the object 52, since there may occur a case where portions which are slightly thinner are produced, the inspection method according to the invention can be applied to this case as effectively as applied to the case where the ribbon-shaped rubber 54 is wound spirally.

The object 52 which constitutes the target for inspection is not limited to the tread portion 56 of the tire, provided that the object 52 is an intermediate product or part thereof which is built on the drum before the tire is vulcanized to be molded. For example, the object 52 may be such as to make up a side wall portion 58, a rim strip portion 60 or a inner liner portion 62 (refer to FIG. 3), and these portions of the tire can be formed by winding circumferentially the ribbon-shaped rubber 54 around the drum until the rubber completes its full circulation around the drum while shifting the ribbon-shaped rubber 54 in the lateral direction every time the rubber completes its circumferential circulation around the drum or winding spirally the ribbon-shaped rubber around the tire building drum 50. In addition, since a belt ply 64 can also be formed by winding a ribbon-shaped material, the belt ply 64 which has not yet been covered with the tread portion 56 can constitute the object which is the target for inspection. Additionally, even in the event that the tread portion 56 is made to constitute the target for inspection, the tread portion 56 may be inspected as part of the green tire as has been described above or as a single part which is formed on the drum 50 with neither a carcass ply 66 nor the like assembled thereto yet.

The tire building drum 50 includes a motor 68 functioning as a rotational driving device 68 so as to be rotated by the motor 68. In addition, a rotational position sensor 70 such as a rotational pulse encoder is provided on the tire building drum 50 which functions as a rotation detecting device for detecting the rotational position of the drum.

The two-dimension laser sensor 12 is a position sensor for detecting a spatial distance to a reflecting surface by emitting a two-dimensional laser beam R having a planar expansion and receiving a reflected light and a known two-dimension laser sensor can be used. Here, as a two-dimension light source which emits the two-dimension laser beam R, there are enumerated, for example, an assembly of laser oscillating elements which are provided in the two-dimensional direction and a configuration in which a spot-like beam is dispersed to be developed in a scattering fashion in the two-dimensional direction. In addition, there is imposed no specific limitation on the output of laser beam, but the output can be set to a predetermined value in the range from 4 to 10 mW.

The two-dimension laser sensor 12, which is configured as has been described above, is placed, as shown in FIG. 1, radially outwards of the tire forming drum 50 in such a manner as to have a detection range which follows the lateral direction of the object 52. Here, a plurality of two-dimension laser sensors 12 are provided in a line in the lateral direction of the object 52 so as to secure a detection range over the overall width thereof.

For example, a normal personal computer or a process control microprocessor is used as the computer 14 which is connected to the two-dimension laser sensors 12, the motor 68 and the rotational position sensor 70. A central processing unit (CPU) 16 of the computer 14 reads in a processing program from a memory 18 when the computer 14 is activated and is adapted to function as a data acquisition unit 20, a data processing unit 22 and a determination unit 24.

The data acquisition unit 20 receives displacement signals (signals representing a distance from the sensor to the reflecting surface) from the two-dimension laser sensors 12 and acquires data on the profile of the object 52 for a single rotation of the drum 50. To be specific, for example, an outer circumferential surface of the object 52 is divided laterally and circumferentially into a plurality finite elements so that the data acquisition unit 20 can receive displacement signals from the individual elements so as to acquire data over the overall width and circumference of the object 52. In addition, the data acquisition unit 20 also can sample displacement signals at a plurality of points which are positioned every predetermined angle along the circumference of the object 52 (for example, at 72 points positioned at intervals of 5°) using the rotational position sensor 70 so as to acquire the displacement signals so sampled as data for a single rotation of the drum. The data for the single rotation that has been so acquired are then stored temporarily in the memory 18.

The data processing unit 22 divides the data which is invoked from the memory 18 into sections of a predetermined width over the object 52 so as to perform harmonic analysis on a radial run-out (RRO) in the circumferential direction of the tire in each section. To be specific, the overall width of the object 52 (to be more specific, the overall width of the measurable width by the two-dimension laser sensors 12) is divided into sections of a predetermined width which is larger than a lateral shifting amount L for each circumferential circulation of the ribbon-shaped rubber 54 around the drum (refer to FIG. 4, normally L=2 to 5 mm), and a lateral displacement signal which is averaged out in each section is made to be a displacement signal of each section, whereby a radial fluctuation in the circumferential direction of the tire is calculated in each section based on the averaged-out displacement signal. A measuring error which is attributed to an inclination or deviation of the ribbon-shaped rubber 54, which is wound around the drum in the way described above, relative to the circumferential direction of the tire can be reduced by setting the width of the sections divided in the way described above larger than the shifting amount L of the ribbon-shaped rubber 54. In addition, preferably, the width by which the data is divided should be in excess of the lateral shifting amount L of the ribbon-shaped rubber 54 but should not exceed 10 times the amount L. In addition, the data processing unit 22 performs a harmonic analysis such as Fourier analysis so as to calculate, for example, first to tenth harmonics using data on RRO in each section calculated in the way described above.

The data processing unit 22 also calculate a harmonic for an RRO which is averaged out over the overall width of the object 52 (an overall RRO) by averaging out harmonics of RRO in the individual sections obtained as described above.

In this embodiment, the determination unit 24 is made up of first, second and third determination units. In the first determination unit, whether or not the amount of irregularities existing locally on the profile of the object 52 falls within a predetermined range is determined from the data stored in the memory 18. For example, the first determination unit extracts displacement signals from a plurality of points which are provided in the lateral and circumferential directions of the object 52 at predetermined intervals (for example, 100 points in the lateral direction and 360 points in the circumferential direction) so as to obtain an average value thereof and calculates differences between the extracted displacement signals of the individual points and the average value for determination of whether or not the differences so calculated fall within a predetermined range (for example, 2 mm or smaller) which is inputted in advance through an input unit 26. Note that instead of comparing the extracted displacement signals of the individual points to the average value, all the data obtained for the single rotation of the drum can also be compared to the average value. Note that as the input unit 26, various types of disk drives such as floppy disk, CD, DVD can be raised in addition to a keyboard.

The determination by the local irregularities amount is preferably effective for detection of abnormality such as a tear of the ribbons-shaped rubber 54. In the event that a tear occurs, since an end portion of the torn rubber becomes unrestrained and appears as a larger displacement than a difference in level on the object 52 which matches the thickness of the ribbon-shaped rubber 54 in the wound state, the tear of the ribbon-shaped rubber 54 can be detected by setting the aforesaid range larger than the thickness.

The second determination unit determines whether or not the magnitude (that is, the amplitude) of the harmonic of the RRO in each section calculated by the data processing unit 22 falls within a predetermined range (for example, 1.0 mm or smaller) which is inputted in advance through the input unit 26 and carries out the determination for every section.

The third processing unit determines whether or not the magnitude (that is, the amplitude) of the harmonic of the overall RRO calculated by the data processing unit 22 falls within a range (for example, 0.5 mm or smaller) which is inputted in advance through the input unit 26.

The results of the determinations carried out in the ways described above are then displayed on a display unit 28. To be specific, in the event that the determination results are not within the ranges and hence a defect is occurring on the object 52, an indication in this respect is displayed on a monitor such as a display or an alarm is raised by a warning device.

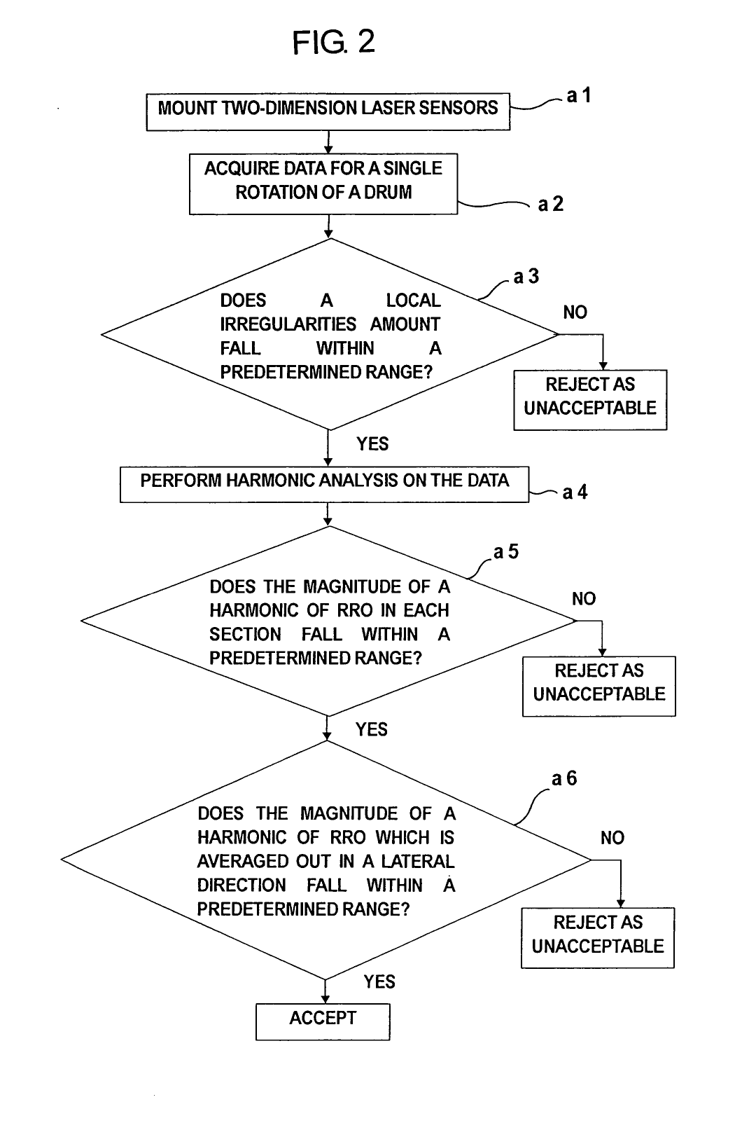

Next, an example of the flow of an inspection process will be described further based on a flowchart shown in FIG. 2.

Firstly, in step a1, the two-dimension laser sensors 12 are mounted radially outwards of the tire building drum 50 in the midst of production, as shown in FIG. 1. Namely, prior to inspection, the object 52 which makes up a tire is built on the tire building drum 50 by shifting the ribbon-shaped rubber 54 in the lateral direction every time the rubber completes its circumferential circulation around the drum or winding the ribbon-shaped rubber 54 spirally around the tire building drum 50, and thereafter, the two-dimension laser sensors 12 are placed radially outwards of the object 52 so built.

Following this, in step a2, data for a single rotation of the drum are acquired by the data acquisition unit 20. To be more specific, a signal is outputted to the motor 68 so as to rotate the tire building drum 50 at a constant speed, and the data acquisition unit 20 receives displacement signals from the two-dimension laser sensors 12 while detecting the rotational position by the rotational position sensor 70 and acquires data on the profile of the object 52 for the single rotation. As this occurs, in order to enhance the measuring accuracy, the data for the single rotation is preferably acquired by acquiring data for several rotations of the drum 50 so as to calculate an average thereover. The data for the single rotation of the drum so acquired are then stored in the memory 18 temporarily.

Next, in step a3, the determination unit 24 determines whether or not the amount of irregularities existing locally on the profile of the object 52 falls within the predetermined range using the data stored in the memory 18, and if the amount falls within the range, the object 52 being built on the drum is acceptable and proceed to the following step a4. On the contrary, the amount exceeds the predetermined range, the determination unit 24 determines that an abnormality such as a tear of the ribbon-shaped rubber 54 is occurring and the object 52 being built on the drum is rejected as unacceptable, an indication in this respect being displayed on the display unit 28.

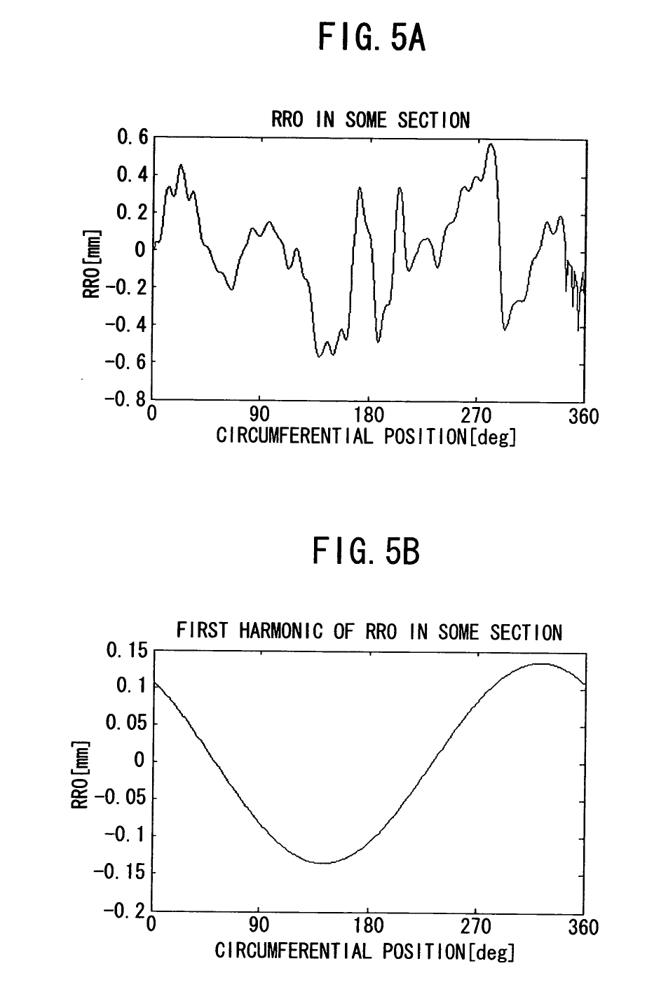

In step a4, the data processing unit 22 performs harmonic analysis on the date invoked from the memory 18. Specifically speaking, the data processing unit 22 performs the harmonic analysis using the data on RRO in the individual sections which are divided by the predetermined width over the object 52. As an example of this, FIG. 5A shows a graph of RRO in some section prior to the harmonic analysis, and FIG. 5B shows a graph of a first harmonic that is obtained by harmonic analysis the RRO in that section.

Next, in step a5, the determination unit 24 determines whether or not the magnitude M of the harmonic (here, the first harmonic) of the RRO in each section obtained through the analysis described above falls within the predetermined range (for example 1. 0 mm or smaller), and if the magnitude of the RRO in every section falls within the predetermined range, the determination unit 24 determines that the object 52 is acceptable and proceed to the following step a6. On the contrary, the magnitude of the RRO exceeds the predetermined range in any of the sections, the determination unit 24 determines that the object 52 is rejected as unacceptable, and an indication in this respect is displayed on the display unit 28.

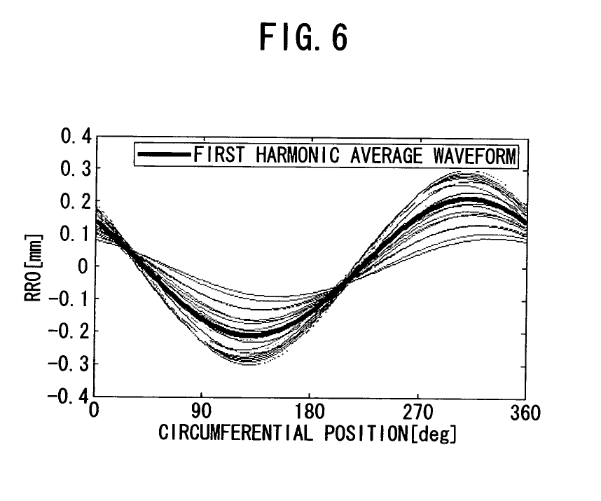

In step a6, firstly, the data processing unit 22 calculates a harmonic for the overall width RRO by averaging out the harmonics (here, the first harmonics) in the individual sections obtained in step a4 over the overall width of the object 52. As an example of this, FIG. 6 shows all waveforms (indicated by thin lines) corresponding to the first harmonics of the RRO in the individual sections and a waveform of the first harmonic of the overall width RRO which results by averaging out the first harmonics of the RRO in the individual sections (an average waveform of the first harmonics and indicated by a thick line).

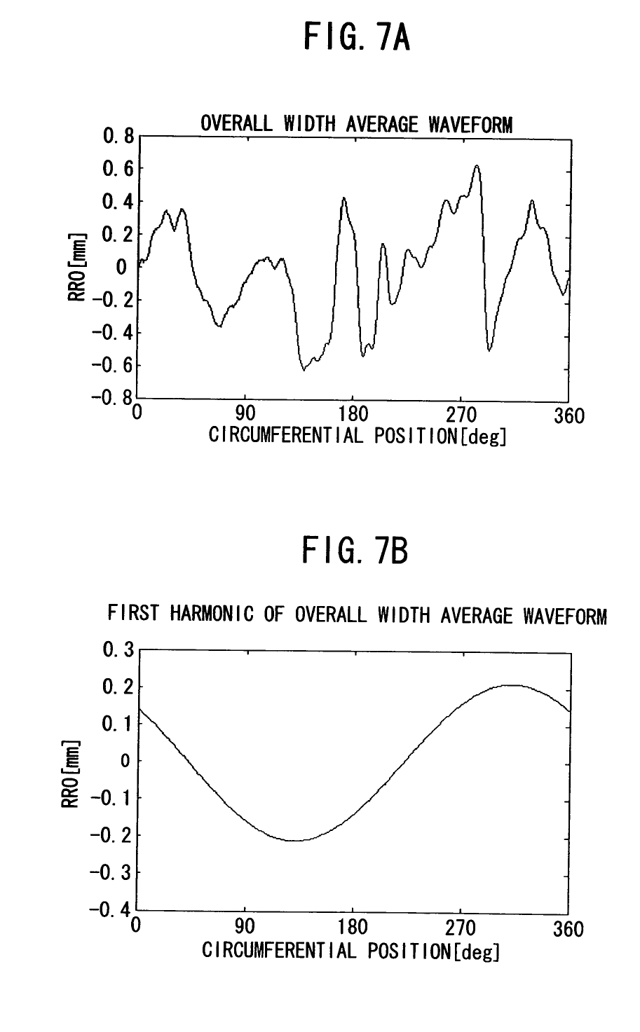

In addition, instead of making use of the results of the analysis carried out in step a4, the harmonic of the overall width RRO (for example, the first harmonic) may be calculated by averaging out the RRO over the overall width of the object 52 using the data obtained in step a2 and performing harmonic analysis on the RRO so averaged out. As an example of this, FIG. 7A shows a graph of an overall width RRO prior to the harmonic analysis, and FIG. 7B shows a graph of a first harmonic that is obtained by harmonic analysis the overall width RRO.

Furthermore, in step a6, the determination unit 24 determines whether or not the magnitude N of the harmonic of the overall width RRO falls within the predetermined range (for example, 0.5 mm or smaller), and if the magnitude N falls within the predetermined range, the determination unit 24 determines that the object 52 is acceptable, and the inspection ends. On the contrary, if the magnitude exceeds the predetermined range, the determination unit 24 determines that the object 52 is rejected as unacceptable, and an indication in this respect is displayed by the display unit 28.

Then, only the objects 52 that have passed the inspection are allowed to proceed to the subsequent tire molding step, where the acceptable objects 52 are finally vulcanized to be molded, whereby pneumatic tires can be obtained.

According to the invention that has been described thus above, by measuring the profile of the object 52 in the planar fashion using the two-dimension sensors 12, the RRO, which affects largely the uniformity of the tire when completed as a final product, can be accurately measured in the midst of production even on the object 52 built by shifting the ribbon-shaped rubber 54 in the lateral direction every time the rubber completes its circumferential circulation around the tire building drum or winding spirally the ribbon-shaped rubber 54 around the tire building drum, and the abnormality such as the tear of the ribbon-shaped rubber 54 can also be detected.

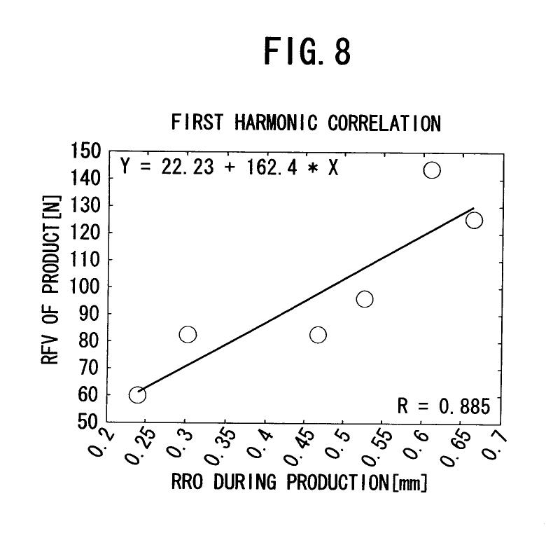

In particular, by determining whether or not the magnitude of the harmonic of the RRO which is averaged out over the overall width of the object 52 falls within the predetermined range, the accuracy at which RFV (radial force variation) of a completed tire as a final product is estimated is enhanced by a simple method so as to enable a simple and accurate detection of defects. As an example of this, FIG. 8 shows according to the embodiment a relationship between the magnitude of a first harmonic of an RRO which is averaged out over the overall width of a tread of a green tire and the magnitude of a first harmonic of RFV of a completed tire as a final product with respect to a radial tire of 235/85R16 in which a tread portion 56 thereof is built by winding spirally a ribbon-shaped rubber 54 of 30 mm wide and 2.5 mm thick around a belt ply 64 (with a lateral shifting amount for each circulation L=3 mm). As is clear from the graph, the correlation coefficient of both the magnitudes is R=0.885, which is high, and hence, it is seen that according to the embodiment, defects can be detected with better accuracy. In addition, in step a2, which has been described above, the acquisition of the data for the single rotation of the drum was carried out by dividing the tread portion of the green tire into a matrix of finite elements with 100 rows which are formed at intervals of 2 mm in the lateral direction and 360 columns in the circumferential direction. In addition, in step a4, the width of the sections divided to obtain RRO's individually was 8 mm. Furthermore, RFV of the completed tire as a final produce was carried out using a uniformity machine under the following conditions: rim size; 16×6.5 JJ, measured air pressure; 300 kPa, measured load; 7.55 kN.

In addition to the determination based on the overall width RRO, by determining whether or not the magnitude of the harmonic of the RRO in each of the laterally aligned sections falls within the predetermined range, the generation of torsional force in the completed tire as a final product can be reduced. In other words, even though the magnitude of RRO in each section is large to some extent, in the event that they are such as to be cancelled when taking the whole of tire into consideration, the RFV of the complete tire becomes small so that the tire is not judged as a defect, and therefore, a determination is performed based on the overall width RRO, and the tolerance therefor is set to be smaller than a tolerance for a determination that is performed based on the RRO in each section (as has been described above, the former tolerance is set to 0.5 mm, whereas the latter tolerance to 1.0 mm). On the other hand, since it is not possible to eliminate a possibility that a torsional force is generated in a completed tire as a final product only by the determination based on the overall width RRO, the determination based on the RRO in each section is also performed so as to reduce the generation of a torsional force.

Thus, as has been described heretofore, according to the invention, since defects can be detected in the midst of production, defects so detected can be dealt with early, so that the amount of defects to be generated can be reduced largely, thereby making it possible to reduce costs for materials. In addition, since the defect section of the mechanical facility can be identified easily and it can be fixed smoothly, the time during which the mechanical facility is out of operation can also be reduced.

Since the invention can measure the profile of an intermediate product in the midst of production which largely affects the uniformity of a completed tire as a final product, the invention can be applied to controlling the production process in producing various types of pneumatic tires.

What is claimed is:

1. An inspection method for inspecting an object built on a tire building drum to make up a pneumatic tire with respect to profile thereof in process of production of the tire, comprising:
acquiring data with respect to a profile of the object for a single rotation of the tire building drum by a two-dimension laser sensor provided in close proximity to the object on the tire building drum and having a detection range along a lateral direction of the object while rotating the drum;
calculating a harmonic of a radial run-out in a circumferential direction of the tire which is averaged out in the lateral direction of the object by performing harmonic analysis on the data so acquired; and determining whether or not the magnitude of the harmonic so calculated falls within a predetermined range.

2. An inspection method as set forth in claim 1, wherein the data is divided into sections by a predetermined width over the object, and wherein harmonic analysis on a radial run-out in a circumferential direction of the tire in each section is performed, and whether or not the magnitude of a harmonic in the circumferential direction of the tire in each section falls within a predetermined range is determined.

3. An inspection method as set forth in claim 1, wherein whether or not the amount of irregularities existing locally on the profile of the object falls within a predetermined range is determined from the data.

4. An inspection method as set forth in claim 2, wherein whether or not the amount of irregularities existing locally on the profile of the object falls within a predetermined range is determined from the data.

5. An inspection method as set forth in claim 2, wherein the object is such as to be built by winding a ribbon-shaped material around the tire building drum while shifting the material laterally every time the material completes its circumferential circulation around the drum or winding the ribbon-shaped material spirally around the drum, and wherein
the predetermined width by which the data is divided into sections is larger than a shifting amount by which the ribbon-shaped material is shifted laterally every time the material completes its circumferential circulation around the drum.

6. An inspection method as set forth in claim 1, wherein a relationship between the magnitude of the harmonic of the radial run-out and the uniformity of a completed tire as a final product is obtained, and a tolerance for the magnitude of the harmonic is obtained from the relationship so obtained, whereby in carrying out the determination, whether or not the magnitude of a calculated harmonic falls within the tolerance is determined.

7. An inspection apparatus for inspecting an object built on a tire building drum to make up a pneumatic tire with respect to profile thereof in process of production of the tire, comprising:
a two-dimension laser sensor provided in close proximity to the object on the tire building drum and having a detection range along a lateral direction of the object;
a data acquisition unit configured to acquire data with respect to a profile of the object for a single rotation of the tire building drum by the two-dimension laser sensor;
a data processing unit configured to calculate a harmonic of a radial run-out in a circumferential direction of the tire which is averaged out in the lateral direction of the object by performing harmonic analysis on the data so acquired; and
a determination unit configured to determine whether or not the magnitude of the harmonic so calculated falls within a predetermined range.

8. An inspection apparatus as set forth in claim 7, wherein
the data processing unit divides the data into sections by a predetermined width over the object and performs harmonic analysis on a radial run-out in a circumferential direction of the tire in each section, and
the determination unit determines whether or not the magnitude of a harmonic in the circumferential direction of the tire in each section falls within a predetermined range.

9. An inspection apparatus as set forth in claim 7, wherein the determination unit determines whether or not the amount of irregularities existing locally on the profile of the object falls within a predetermined range from the data.

10. An inspection apparatus as set forth in claim 8, wherein the determination unit determines whether or not the amount of irregularities existing locally on the profile of the object falls within a predetermined range from the data.

11. An inspection apparatus as set forth in claim 8, wherein
the object is such as to be built by winding a ribbon-shaped material around the tire building drum while shifting the material laterally every time the material completes its circumferential circulation around the drum or winding the ribbon-shaped material spirally around the drum, and wherein
the predetermined width by which the data is divided into sections is larger than a shifting amount by which the ribbon-shaped material is shifted laterally every time the material completes its circumferential circulation around the drum.

12. An inspection apparatus as set forth in claim 7, wherein the determination unit determines whether or not the magnitude of the harmonic of the radial run-out falls within a tolerance determined based on the magnitude of the harmonic of the radial run-out and the uniformity of a completed tire as a final product.

13. A pneumatic tire production method comprising:
building on a tire building drum an object which makes up a pneumatic tire by winding a ribbon-shaped material around the tire building drum while shifting the material laterally every time the material completes a single circumferential circulation around the drum or winding spirally the ribbon-shaped material around the drum;
acquiring data with respect to a profile of the object for a single rotation of the drum by a two-dimension laser sensor provided in close proximity to the object on the tire building drum and having a detection range along the lateral direction of the object while rotating the drum;
calculating a harmonic of a radial run-out in a circumferential direction of the tire which is averaged out in the lateral direction of the object by performing harmonic analysis on the data so acquired, and determining whether or not the magnitude of the harmonic so calculated falls within a predetermined range; and
vulcanizing to mold a pneumatic tire using the object for which the magnitude of the harmonic is determined to fall within the predetermined range.

14. A pneumatic tire production method as set forth in claim 13, wherein the data is divided into sections by a predetermined width over the object, and wherein harmonic analysis on a radial run-out in a circumferential direction of the tire in each section is performed, and whether or not the magnitude of a harmonic in the circumferential direction of the tire in each section falls within a predetermined range is determined.

15. A pneumatic tire production method as set forth in claim 13, wherein whether or not the amount of irregularities existing locally on the profile of the object falls within a predetermined range is determined from the data.

16. A pneumatic tire production method as set forth in claim 14, wherein whether or not the amount of irregularities existing locally on the profile of the object falls within a predetermined range is determined from the data.

17. A pneumatic tire production method as set forth in claim 14, wherein the predetermined width by which the data is divided into sections is larger than a shifting amount by which the ribbon-shaped material is shifted laterally every time the ribbon-shaped material completes its circumferential circulation around the drum.

18. A pneumatic tire production method as set forth in claim 13, wherein a relationship between the magnitude of the harmonic of the radial run-out and the uniformity of a completed tire as a final product is obtained, and a tolerance for the magnitude of the harmonic is obtained from the relationship so obtained, whereby in carrying out the determination, whether or not the magnitude of a calculated harmonic falls within the tolerance is determined.
